(19) United States
(12) Patent Application Publication
(10) Pub. No.: US 2011/0128382 A1
(43) Pub. Date: Jun. 2, 2011

(54) SYSTEM AND METHODS FOR GAMING DATA ANALYSIS

(76) Inventors: Richard Pennington, Reno, NV (US); Bin Nguyen, Reno, NV (US)

(21) Appl. No.: 12/628,753

(22) Filed: Dec. 1, 2009

(51) Int. Cl. H04N 7/18

(52) U.S. Cl. 348/153; 348/E07.085

(57) ABSTRACT

A system for analyzing data generated by surveillance of a casino is provided. The system includes a plurality of cameras. Each camera is positioned with respect to a corresponding section of the casino and configured to digitally record a video segment upon detection of at least one defined trigger within the corresponding section and generate a signal indicative of the recorded video segment. A video surveillance center is in signal communication with each camera and includes a database configured to store a plurality of defined behaviors and a plurality of defined indicators that are each associated with at least one trigger. The video surveillance center is configured to receive content including the recorded video segment from at least one camera and analyze the content to identify the at least one defined trigger.

### BACKGROUND OF THE INVENTION

This invention relates generally to systems and methods for analyzing gaming data and, more particularly, to systems and methods for searching recorded video repositories to monitor defined triggers based on queries that are defined in real-time.

Video surveillance systems have been widely employed within casino properties, as well as at other locations, such as at airports, banks, subways and public areas, in an attempt to record, and/or to deter criminal activity. However, conventional video surveillance systems have limited capabilities to record, transmit, process, and store video content. For example, many of these conventional video surveillance systems require human operators to monitor one or more video screens to detect potential criminal activity and/or suspect situations. As such, the effectiveness of such video surveillance systems may depend upon an awareness and/or an expertise of the operator.

In order to overcome this problem, video surveillance systems have been developed which analyze and interpret captured video. For example, some known video surveillance systems analyze video content to identify human faces. At least some of these video surveillance systems incorporate computer vision and pattern recognition technologies to analyze information from sensors positioned within an environment. Data recorded by the sensors is analyzed to generate events of possible interest within the environment. For example, an event of interest at a departure drop off area in an airport may include cars that remain in a passenger loading zone for extended periods of time. These smart surveillance technologies typically are deployed as isolated applications which provide a particular set of functionalities. Isolated applications, while delivering some degree of value to the user, generally do not comprehensively address the security requirements.

As such, a more comprehensive approach is needed to address security needs for different applications as well as provide flexibility to facilitate implementation of these applications.

### BRIEF DESCRIPTION OF THE INVENTION

In one aspect, a system for analyzing data generated by surveillance of a casino is provided. The system includes a plurality of cameras. Each camera of the plurality of cameras is positioned with respect to a corresponding section of the casino and configured to digitally record a video segment upon detection of at least one defined trigger within the corresponding section, and generate a signal indicative of the recorded video segment. A video surveillance center is in signal communication with each camera, and includes a database configured to store a plurality of defined triggers. The video surveillance center is configured to receive content including the recorded video segment from at least one camera of the plurality of cameras and analyze the content to identify the at least one defined trigger.

In another aspect, a method is provided for monitoring activity on a casino property. The method includes defining a plurality of triggers that are associated with a plurality of indicators and a plurality of behaviors. A metadata annotation is defined corresponding to each defined trigger of the plurality of defined triggers. A video stream including a plurality of timecodes associated with the video stream is received by a video surveillance center from a camera positioned on the casino property. Each timecode of the plurality of timecodes corresponds to a portion of the received video stream. The received video stream is analyzed to identify at least one defined trigger of the plurality of defined triggers at a corresponding timecode within the received video stream, and a corresponding metadata annotation is stored at a corresponding timecode.

In yet another aspect, a method for monitoring activity on a casino property is provided. The method includes accessing at least one defined trigger from a database including a plurality of defined triggers and accessing at least one metadata annotation corresponding to the at least one defined trigger, wherein each trigger is associated with at least one of a plurality of behaviors and a plurality of indicators. Content is received from a camera positioned on the casino property having a plurality of timecodes associated with the content. Each timecode of the plurality of timecodes corresponds to a portion of the received content. The received content is analyzed to identify the at least one accessed defined trigger within the received content. The at least one metadata annotation and at least one timecode of the plurality of timecodes corresponding to the at least one accessed defined trigger is identified, and the at least one identified metadata annotation and the at least one corresponding timecode are stored in the database.

### BRIEF DESCRIPTION OF THE DRAWINGS

FIG. 1 is a schematic view of a system for use in analyzing data generated by surveillance of a casino property;

FIG. 2 shows an exemplary method for monitoring activity on a casino property; and

FIG. 3 shows an exemplary method for monitoring activity on a casino property.

### DETAILED DESCRIPTION OF THE INVENTION

The present disclosure is directed to an exemplary system and method for searching recorded video repositories to locate events, patterns and/or triggers based on one or more queries that are defined in real-time. For example, a query might be executed to determine a demographic characteristic for a certain blackjack player who typically plays at 4:00 p.m. on Thursday or the number of hands of poker played by a certain female player in a given time period. Unlike conventional systems and methods, the video analytic system and method described herein can perform unstructured searches to provide useful information to a casino operator for analytic purposes including, without limitation, data manipulation. Although the systems and methods are described herein with reference to a video surveillance system for a casino property, it should be apparent to those skilled in the art and guided by the teachings herein provided that the system and the methods may be incorporated within any suitable environment, such as within airports, banks, subways and/or public areas, to record and/or to prevent criminal activity.

The exemplary systems described herein include a plurality of smart video cameras positioned to scan or cover at least a portion of a casino property, such as at least a portion of a casino gaming floor. More specifically, in one embodiment each video camera is configured to monitor a corresponding portion of the gaming floor, and video segments or clips are stored in a database that includes a storage array. The system categorizes and searches the video repository as described in greater detail herein.

A plurality of pre-defined behaviors or indicators, associated with at least one trigger, is stored within the database. When one or more of the pre-defined triggers are detected or recorded by one of the smart video cameras of the system, the system triggers an alarm signal, records a section of video, and/or performs another suitable action. The video stream is enhanced by the addition of semantically-searchable information that may be queried to facilitate locating all relevant recorded video. As a result, the user is able to create a query for searching recorded video data based on a specific video content, and not only based on a time-stamp or a timecode. Identification and analysis of the detected defined triggers facilitate enabling the casino operator to determine which games are most popular, how people are attracted to the various games and amenities of the casino, and the adequacy of the casino games and/or amenities, for example.

As used herein, the term triggers may include, without limitation, behaviors or indicators, such as, a gender of a person, a size (a height and/or a weight) of a person and/or relative dimensions and/or ratios of the person's height and weight, an exclusion of a group of people, such as a child, facial features of the person including eye color, nose size, facial hair (a mustache and/or a beard), and/or eyeglasses, objects that a person is carrying, such as a purse, luggage or a carrying bag, particular objects including a type and brand of beverage, or a logo of a clothing maker, a direction of travel, a mode of travel (walking, running or moving in a wheelchair), a speed at which the person is traveling, certain actions of the person, such as stopping, pausing, sitting, eating, drinking, celebrating, conversing with other people, gathering in a crowd (a number of people in the crowd, a number of heads per square foot of the casino floor), altercations between players and/or casino employees, and a frequency, a location and/or a time of actions, an age of the person, a person's mood (celebratory, happy, confused, angry, intoxicated or lost), a marital status of a person (identification of a wedding ring or a wedding band), and a length of a line of people or a wait time at a gaming table, a casino restaurant, a buffet, or an automated teller machine (ATM).

For example, a user, such as a system operator or casino security member, may want to search the video data for a person or a group of people waving their hands in the air. A person may wave his or her hand to draw attention of a cocktail waitress, or they may be excited about winning a jackpot on a slot machine or other casino game. Video analytics and machine event records provide a more complete detail of this action sequence.

Additionally, a user may want to monitor arrival of a person or a group of people, such as a husband and a wife, at the casino. Combining player tracking data and video analytics may provide the operator with important information to better target the casino's hospitality efforts, such as giving a $10 guaranteed play to the spouse, for example. Further, a patron might always come in and sit at the bar for a time period, such as about 30 minutes, before moving to a machine or a gaming table. The video data may provide useful clues to the person's behavior to enable the casino operator to better optimize the player's value.

The exemplary systems described herein automatically generate metadata annotations, similar in one embodiment to EXIF or MPEG7 metadata, that are recorded as an extra stream in the video file or in a separate text-based file. The annotations are searchable and may include information generated directly from the video stream, as well as additional information, such as player tracking data, jackpot event data, and human created notes. In addition, although it is contemplated that most annotations are generated in real-time, the system is also configurable to perform post-processing of recorded video to generate annotations. Digital video streams incorporate digital timecodes, so post-processing yields substantially equivalent results.

The exemplary systems and methods described herein utilize video analytics and defined behaviors for creating at least some of the metadata annotations of the video streams. For example, one behavior that might trigger an annotation may be sliding a stack of playing chips forward on a table. Another behavior might include a player sitting down at a slot machine. The system is more useful as the number of recognized or defined behaviors is increased. As a result, in one embodiment the system is configurable to re-analyze existing recorded video after additional behaviors are added or programmed into the system.

In one embodiment, the annotations are recorded in a database file associated with the recorded video, such that multiple annotations may be easily associated with the same event, behavior, and/or timecode in the video. It is also possible to assign weights to different types of metadata, such that a query produces results that are ranked by how closely the corresponding defined behaviors match the stated query.

In one embodiment, the system includes multiple video streams that each include a unique identifier, such as a camera identification number, as well as a standard timecode. As a result, queries consolidate data obtained from a plurality of sources to produce the most relevant information. For example, if an operator queries the system to identify the female blackjack players who typically play at 4:00 p.m. on Thursday, the system analyzes the video streams from the cameras scanning or covering all of the blackjack tables within the casino, player tracking data if available, and any other suitable data generated in the blackjack pit area to provide the answers to the query. Additional queries may include, without limitation, a percentage of poker players that are female, how the percentage of female poker players changes during a weekend, such as when a popular sporting event is broadcast, trends in demographics of the weekend slot machine players within the casino since a new nightclub opened in the casino, for example, and trends toward different types of players since a new housing development opened nearby and the concurrently offered local resident promotions. Further examples include querying the system to look for patterns wherein the casino had an unusual loss at the tables and seeing if any particular players are showing up on the floor at the same time, possibly indicating that someone has developed a system for cheating the casino.

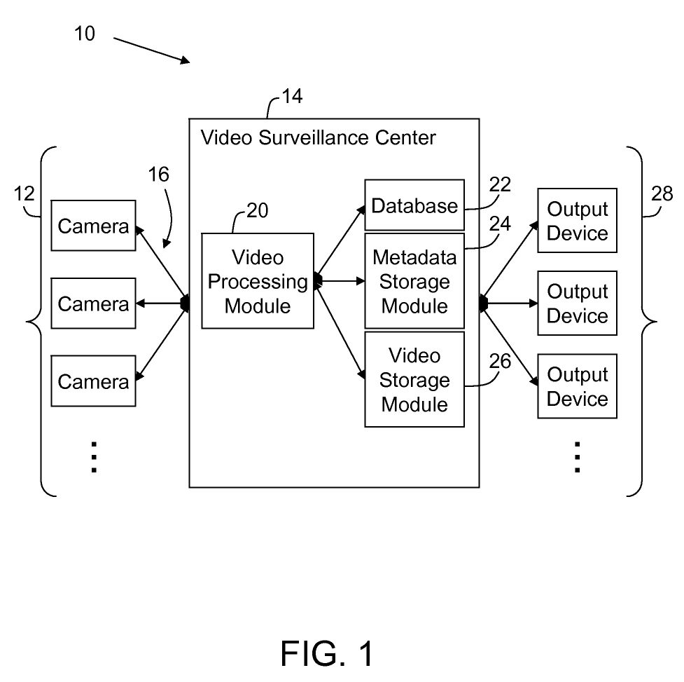

FIG. 1 illustrates an exemplary system 10 for use in monitoring activity within a casino property and analyzing data generated by surveillance of the casino property. In one embodiment, system 10 includes one or more cameras 12, such as smart cameras, positioned separately throughout a casino floor to track people including game players, visitors, hotel guests and employees. Each camera 12 is coupled to a video surveillance center 14 that includes one or more main computers (not shown) via a communication network 16. Moreover, each camera 12 may be any suitable digital camera that is capable of generating image sequences, and/or any analog camera that is capable of generating image sequences, in which case the analog camera is coupled to a converter that transforms the analog image information to digital image data and that then provides the digital image data to communication network 16. Communication network 16 may include any suitable communication network that is configured to communicate digital image information, such as a wireline or wireless data communication network, such as a local area network (LAN) or a wireless local area network (W-LAN) or a Wide Area Network (WAN). Wireless networks enhance the flexibility of system 10, and enable cameras 12 to be positioned throughout the casino property as surveillance needs dictate.

In one embodiment, each camera 12 is positioned within a corresponding section of the casino floor to survey that section and each is programmed to digitally record a video segment upon detection of one or more pre-defined behaviors or indicators. Upon detection of the one or more defined behaviors, camera 12 is activated to digitally record a video segment. Camera 12 generates a signal indicative of the recorded video segment and transmits the signal to video surveillance center 14. In one embodiment, each camera 12 includes a unique identifier to facilitate consolidation of data received by video surveillance center 14 from cameras 12.

As shown in FIG. 1, in the exemplary embodiment, video surveillance center 14 includes a video processing module 20 that includes one or more suitable processors for receiving data for subsequent processing, and a database 22 that is coupled in communication with video processing module 20. Video processing module 20 receives information from, and transmits control signals to, cameras 12 and/or database 22 to facilitate operation of system 10. As used herein, the term “processor” is not limited to only integrated circuits referred to in the art as a processor, but broadly refers to a computer, a microcontroller, a microcomputer, a programmable logic controller, an application-specific integrated circuit and/or any other programmable circuit. In certain embodiments, video processing module 20 includes multiple individual processors, whether operating in concert or independently of each other. Although elements of video surveillance center 14 are illustrated in FIG. 1 as being separate components, in other embodiments, various elements of video surveillance center 14 may be jointly implemented in a single physical component, or each may be further subdivided into additional physical components. Operable communication between the various system elements is depicted in FIG. 1 via arrowhead lines, which illustrate either signal communication or mechanical operation, depending on the system element involved. Moreover, operable communication among the various system elements may be obtained through a hardwired or a wireless arrangement, or a combination thereof.

Video processing module 20 analyzes video streams, to produce compressed video and video metadata as outputs. In some embodiments, video processing module 20 scans video metadata for patterns or behaviors that match a set of predefined rules, producing alerts (or search results, in the case of prerecorded metadata) when patterns or behavior matches are found, which can then be transmitted to one or more output devices (described in greater detail below). Examples of metadata used by video processing module 20 when processing the video segment include, without limitation, object identification, object type, date/time stamps, current camera location, previous camera locations, and/or directional data.

Database 22 stores a plurality of defined behaviors utilized to activate one or more cameras 12 to begin recording a video segment upon detection of one or more behaviors stored in database 22. With the video segment recorded by camera 12, video surveillance center 14 receives content that includes the recorded video segment from camera 12 and analyzes the content to identify the one or more defined behaviors captured within the recorded video segment. The content includes a plurality of timecodes associated with the recorded video segment. Each timecode corresponds to a portion of the recorded video segment. Video surveillance center 14 analyzes the content to identify at least one timecode that corresponds to the at least one behavior. In one embodiment, the timecodes are stored in database 22. Moreover, video surveillance center 14 also reanalyzes the recorded video segment after database 22 is updated with additional defined behaviors.

In one embodiment, cameras 12 collect and transmit signals representing camera outputs to video processing module 20 using one or more suitable transmission techniques. For example, the signals can be transmitted via LAN and/or a WAN, broadband connections, and/or wireless connections, such as a BLUETOOTH device, and/or any suitable transmission technique known to those skilled in the art and guided by the teachings herein provided. The received signals are processed within video processing module 20 and transmitted to database 22. System 10 uses a metadata storage module, described in greater detail below, to facilitate analyzing and/or categorizing content received by video surveillance center 14 from cameras 12. Video surveillance center 14 is configured to automatically generate at least one metadata annotation corresponding to the at least one defined behavior and to identify the at least one metadata annotation corresponding to the at least one defined behavior. In a particular embodiment, the at least one identified metadata annotation is stored in database 22.

Further, in the exemplary embodiment database 22 includes a video storage module 24 and a metadata storage module 26. Video storage module 24 stores video captured by system 10. Video storage module 24 may include VCRs, DVRs, RAID arrays, USB hard drives, optical disk recorders, flash storage devices, image analysis devices, general purpose computers, video enhancement devices, de-interlacers, scalers, and/or other video or data processing and storage elements for storing and/or processing video. Video signals can be captured and stored in various analog and/or digital formats, including, without limitation, Nation Television System Committee (NTSC), Phase Alternating Line (PAL), and Sequential Color with Memory (SECAM), uncompressed digital signals using DVI or HDMI connections, and/or compressed digital signals based on a common codec format (e.g., MPEG, MPEG2, MPEG4, or H.264).

Metadata storage module 26 stores metadata captured by system 10 and cameras 12, as well as defined rules against which the metadata is compared to when determining if alerts should be triggered. Metadata storage module 26 may be implemented on a sever class computer that includes application instructions for storing and providing alert rules to video processing module 20. Examples of database applications that can be used to implement video storage module 24 and/or metadata storage module 26 include, but are not limited to only including, MySQL Database Server by MySQL AB of Uppsala, Sweden, the PostgreSQL Database Server by the PostgreSQL Global Development Group of Berkeley, Calif., or the ORACLE Database Server offered by ORACLE Corp. of Redwood Shores, Calif. In certain embodiments, video storage module 24 and metadata storage module 26 may be implemented on one server using, for example, multiple partitions and/or instances such that the desired system performance is obtained.

Alerts created by video surveillance center 14, such as those created by video processing module 20, are transmitted to one or more output devices 28, such as smart terminal, a network computer, one or more wireless devices (e.g., hand-held PDAs), a wireless telephone, an information appliance, a workstation, a minicomputer, a mainframe computer, and/or any suitable computing device that can be operated as a general purpose computer, or to a special purpose hardware device used solely for serving as an output device 28 in system 10. In one embodiment, casino security members are provided with wireless output devices 28 that include text, messaging, and video capabilities as they patrol the casino property. As alerts are generated, messages are transmitted to output devices 28, directing the security members to a particular location. In certain embodiments, video segments are included in the messages, providing the security members with visual confirmation of the person or object of interest.

In one embodiment, video surveillance center 14 receives a query from an operator, such as a casino security member. The query may be directed to at least one of a stored metadata annotation corresponding to the at least one defined behavior and a stored timecode corresponding to a portion of the recorded video segment. In one embodiment, video surveillance center 14 assigns a weight to the at least one metadata annotation, to enable the rank results of the query to be rank ordered. Further, in such an embodiment, video surveillance center 14 may also assign a weight to the at least one metadata annotation, wherein the weight is rankable to provide a result for a query received by video surveillance center 14 from the operator.

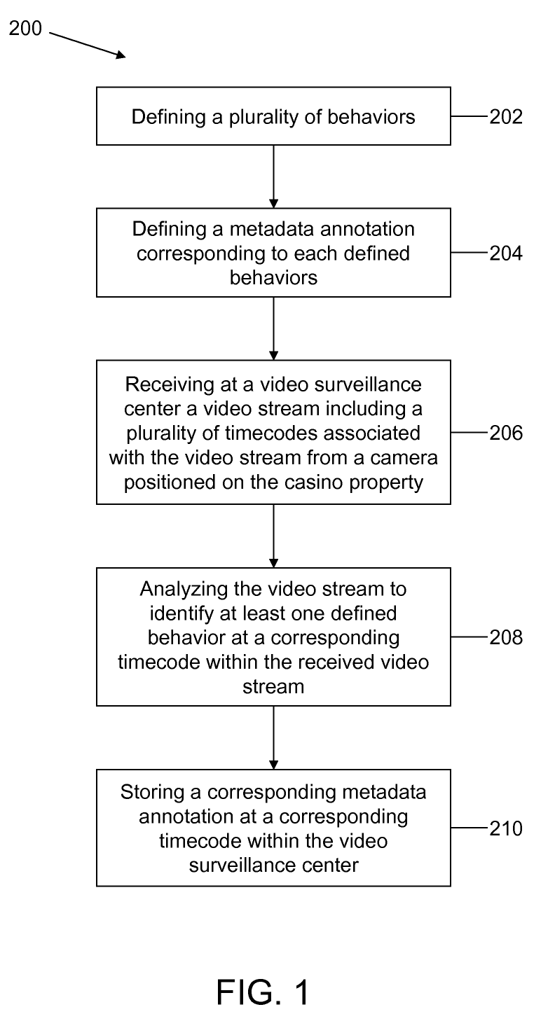

Referring to FIG. 2, an exemplary method 200 is described for use in monitoring activity on a casino property. Method 200 may be embodied on a computer readable medium, such as a computer program, and/or implemented and/or embodied by any other suitable means. The computer program may include a code segment that, when executed by a processor, configures the processor to perform one or more of the functions of method 200.

A video surveillance center defines 202 a plurality of behaviors and defines 204 a metadata annotation corresponding to each defined behaviors. The video surveillance center receives 206, from a camera positioned on the casino property, a video stream including a plurality of timecodes associated with the video stream. Each timecode of the plurality of timecodes corresponds to a portion of the received video stream. The received video stream is analyzed 208 to identify at least one defined behavior or indicators of the plurality of defined behaviors or plurality of defined indicators at a corresponding timecode within the received video stream, and a corresponding metadata annotation at a corresponding timecode is stored within the video surveillance center, such as within a database. In one embodiment, the corresponding metadata annotation is stored in one of the video stream and an independent video file.

Moreover, in one embodiment, the video surveillance center receives from a user or operator, a query request to identify at least one defined behavior or indicator. A query on stored metadata annotations corresponding to the at least one identified defined behavior is performed at the corresponding timecode in the received video stream, and query results are provided to the user. Further, a plurality of video streams may be analyzed and metadata annotations for the plurality of video streams may be stored, and a query is performed on the stored metadata annotations. In one exemplary embodiment, the metadata annotations for each timecode are stored and a weight is assigned to each metadata annotation of the plurality of metadata annotations to facilitate sorting the plurality of timecodes.

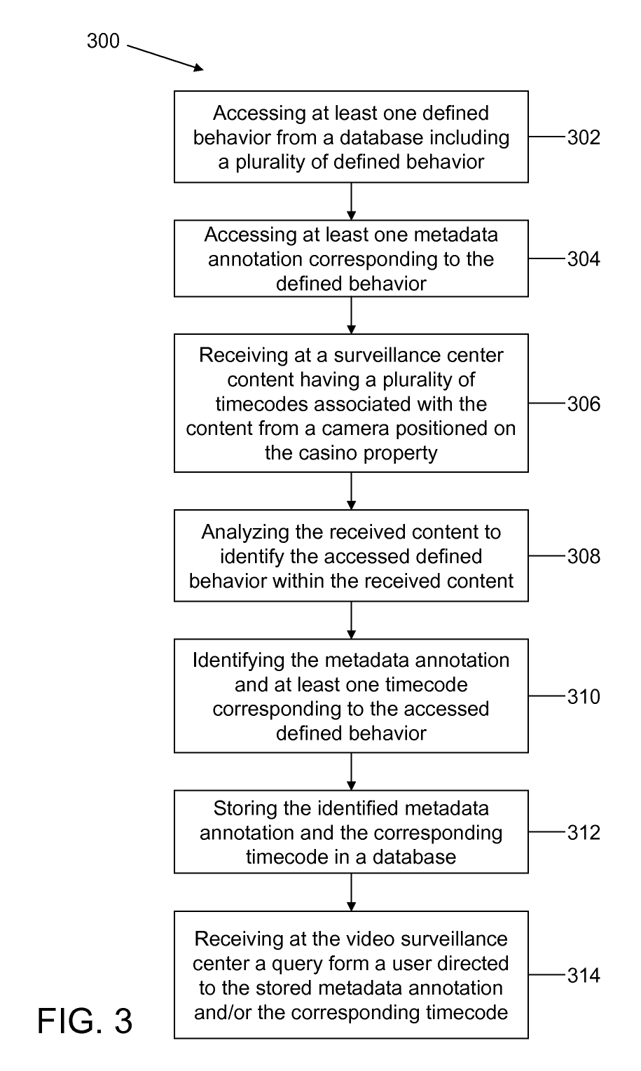

In one embodiment, a method 300 is provided for use in monitoring activity on a casino property, as shown in FIG. 3. At least one defined behavior or indicator is accessed 302 from a database including a plurality of defined behaviors. The database is coupled to a video surveillance center, such as to a main computer. At least one metadata annotation corresponding to the defined behavior or indicator is then accessed 304. In one embodiment, the behaviors and/or indicators and the at least one metadata annotation are defined and stored in the database. A video surveillance center receives 306, from a camera positioned on the casino property, video and/or audio content having a plurality of timecodes associated with the content. In one embodiment, the identified metadata annotation and/or the corresponding timecode are stored within the received content. The video surveillance center may receive video content and/or audio content from one or more video cameras positioned on the casino floor. In one embodiment, the video surveillance center receives, from one or more cameras positioned on the casino property, a stream of video data in real-time. Each timecode corresponds to a portion of the received content. The received content is analyzed 308 to identify the accessed defined behavior or indicator within the received content. The metadata annotation and at least one timecode corresponding to the accessed defined behavior are identified 310, and the identified metadata annotation and the corresponding timecode are stored 312 in the database. The identified metadata annotation and the corresponding timecode are stored separately from the received content.

In another embodiment, the video surveillance center receives 314, from a user, a query directed to the stored metadata annotation and/or the corresponding timecode. The received query is performed to generate query results, and the query results are provided to the user. In a particular embodiment, the received query includes assigning a weight to the defined behavior to enable sorting of the plurality of defined behaviors.

A technical effect of the system and methods described herein as they relate to a system and methods for monitoring activity within a casino property includes at least one of (a) defining a plurality of behaviors and/or a plurality of indicators (b) defining a metadata annotation corresponding to each defined behavior or indicator of the plurality of defined behaviors and defined indicator; (c) receiving from a camera positioned on the casino property a video stream including a plurality of timecodes associated with the video stream, each timecode of the plurality of timecodes corresponding to a portion of the received video stream; (d) analyzing the received video stream to identify at least one defined behavior or defined indicator at a corresponding timecode within the received video stream; and (e) storing a corresponding metadata annotation at a corresponding timecode.

An additional technical effect of the systems and methods described herein as they relate to a system and methods for monitoring activity on a casino property include at least one of (e) accessing at least one defined behavior from a database including a plurality of defined behaviors; (f) accessing at least one metadata annotation corresponding to the at least one defined behavior; (g) receiving from a camera positioned on the casino property content having a plurality of timecodes associated with the content, each timecode of the plurality of timecodes corresponding to a portion of the received content; (h) analyzing the received content to identify the at least one accessed defined behavior within the received content; (i) identifying the at least one metadata annotation and at least one timecode of the plurality of timecodes corresponding to the at least one accessed defined behavior; and (j) storing the at least one identified metadata annotation and the at least one corresponding timecode in the database.

The present disclosure describes a system and a method providing flexible and powerful means for generating and analyzing information that incorporates video segments and player tracking, for example, to provide the casino operator with a complete picture of the casino operations. Rather than defining a range of potentially useful information before actions occur, the system and the method as described herein allow the casino operator to determine what events, actions and/or behaviors are potentially important indicators of the casino operations. The analyzed information can then be utilized to optimize casino operations and customer relations

A casino security system is provided herein, in which casino managers may be provided with useful information in real-time regarding activities within the casino property, for example, on the casino gambling floor, which have been automatically detected rather than relying on a visual inspection of the video content to identify one or more defined behaviors. This information can greatly aid analysis of the video stream from one or more cameras positioned about the casino property to detect activities with which the casino managers are concerned, such as criminal activity including theft and/or cheating.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for analyzing data generated by surveillance of a casino, said system comprising:
a plurality of cameras, each of said plurality of cameras is positioned to survey a corresponding section of the casino and is configured to digitally record a video segment upon detection of at least one pre-defined trigger within the corresponding section and generate a signal indicative of the recorded video segment; and
a video surveillance center in communication with each said camera, said video surveillance center comprising a database configured to store at least one of a plurality of defined behaviors and a plurality of defined indicators, said at least one pre-defined trigger associated with at least one of said plurality of defined behaviors and said plurality of defined indicators, said video surveillance center configured to receive content including the recorded video segment from at least one of said plurality of cameras and to analyze the content to identify the at least one defined trigger.

2. A system in accordance with claim 1 wherein each of said plurality of cameras is programmed to digitally record the video segment upon detection of the at least one defined trigger.

3. A system in accordance with claim 1 wherein said video surveillance center is further configured to automatically generate at least one metadata annotation corresponding to the at least one defined trigger.

4. A system in accordance with claim 3 wherein said video surveillance center is further configured to identify the at least one metadata annotation corresponding to the at least one defined trigger.

5. A system in accordance with claim 4 wherein the at least one identified metadata annotation is stored in said database.

6. A system in accordance with claim 1 wherein the content includes a plurality of timecodes associated with the recorded video segment, each timecode of the plurality of timecodes corresponding to a portion of the recorded video segment, the video surveillance center configured to analyze the content to identify at least one timecode of the plurality of timecodes corresponding to the at least one defined trigger.

7. A system in accordance with claim 6 wherein the plurality of timecodes are stored in said database.

8. A system in accordance with claim 1 wherein said video surveillance center is further configured to receive a query from an operator, wherein the query is directed to at least one of a stored metadata annotation corresponding to the at least one defined trigger and a stored timecode of the plurality of timecodes corresponding to a portion of the recorded video segment.

9. A system in accordance with claim 8 wherein said video surveillance center is further configured to assign a weight to the at least one metadata annotation, and rank results of the query.

10. A system in accordance with claim 1 wherein said video surveillance center is further configured to reanalyze the recorded video segment after said database is updated with additional defined triggers.

11. A system in accordance with claim 1 wherein said video surveillance center is further configured to assign a weight to the at least one metadata annotation, wherein the weight is rankable to provide a result for a query received by said video surveillance center from an operator.

12. A system in accordance with claim 1 wherein each of said plurality of cameras includes a unique identifier to facilitate consolidation of data received by said video surveillance center from said plurality of cameras.

13. A method for monitoring activity on a casino property, the method comprising:
defining a plurality of triggers, wherein each of the triggers is associated with at least one of a plurality of behaviors and a plurality of indicators;
defining a metadata annotation corresponding to each defined trigger of the plurality of defined triggers;
receiving from a camera positioned on the casino property a video stream including a plurality of timecodes associated with the video stream, each timecode of the plurality of timecodes corresponding to a portion of the received video stream;
analyzing the received video stream to identify at least one defined trigger of the plurality of defined triggers at a corresponding timecode within the received video stream; and
storing a corresponding metadata annotation at a corresponding timecode.

14. A method in accordance with claim 13 wherein the corresponding metadata annotation is stored in one of the video stream and an independent video file.

15. A method in accordance with claim 13 further comprising:
receiving a query request to identify at least one defined trigger;
performing a query on stored metadata annotations corresponding to the at least one identified defined trigger at the corresponding timecode in the received video stream; and
providing query results to a user.

16. A method in accordance with claim 13 further comprising:
analyzing a plurality of video streams;
storing metadata annotations for the plurality of video streams; and
performing a query on the stored metadata annotations.

17. A method in accordance with claim 13 further comprising:
storing a plurality of metadata annotations for each timecode; and
assigning a weight to each metadata annotation of the plurality of metadata annotations to facilitate sorting the plurality of timecodes.

18. A method for monitoring activity on a casino property, the method comprising:
accessing at least one defined trigger from a database including a plurality of defined triggers that are each associated with at least one of a plurality of behaviors and a plurality of indicators;
accessing at least one metadata annotation corresponding to the at least one defined trigger;
receiving from a camera positioned on the casino property content having a plurality of timecodes associated with the content, each timecode of the plurality of timecodes corresponding to a portion of the received content;
analyzing the received content to identify the at least one accessed defined trigger within the received content;
identifying the at least one metadata annotation and at least one timecode of the plurality of timecodes corresponding to the at least one accessed defined trigger; and
storing the at least one identified metadata annotation and the at least one corresponding timecode in the database.

19. A method in accordance with claim 18 further comprising defining the plurality of triggers.

20. A method in accordance with claim 18 further comprising defining the at least one metadata annotation.

21. A method in accordance with claim 18 wherein receiving from a camera positioned on the casino property content having a plurality of timecodes associated with the content comprises receiving at least one of video content and audio content.

22. A method in accordance with claim 18 wherein receiving from a camera positioned on the casino property content having a plurality of timecodes associated with the content comprises receiving a stream of video data in real-time.

23. A method in accordance with claim 18 wherein the at least one identified metadata annotation and the at least one corresponding timecode are stored within the received content.

24. A method in accordance with claim 18 wherein storing the at least one identified metadata annotation and the at least one corresponding timecode are stored separately from the received content.

25. A method in accordance with claim 18 further comprising:
receiving, from a user, a query directed to at least one of the at least one stored metadata annotation and the at least one corresponding timecode;
performing the received query to generate query results; and
providing the query results to the user.

26. A method in accordance with claim 25 wherein performing the received query comprises assigning a weight to the at least one defined trigger to enable sorting of the plurality of defined trigger.
